(19) United States
(12) Patent Application Publication
(10) Pub. No.: US 2011/0185902 A1
(43) Pub. Date: Aug. 4, 2011

(54) COLUMN FOR BRINGING TWO FLUIDS INTO CONTACT

(76) Inventors: Rupert Wagner, Worms (DE); Gerd Modes, Bad Kreuznach (DE); Volker Giesen, Friedelsheim (DE)

(21) Appl. No.: 12/594,431

(22) PCT Filed: Jun. 5, 2009
(86) PCT No.: PCT/EP09/56973

§ 371 Date: Oct. 2, 2009

(30) Foreign Application Priority Data
Jun. 6, 2008 (EP) 08157792.6

(51) Int. Cl. B01D 47/14; B21K 21/16

(52) U.S. Cl. 95/211; 261/113; 29/401.1

(57) ABSTRACT

A column for bringing two fluids into contact, which column possesses an essentially cylindrical shell which, between a top end and a bottom end of the column, surrounds an interior space in which packings are axially spaced apart along a longitudinal axis extending from the top to the bottom end of the column. The packings, at the periphery thereof, are bounded by side walls which are inclined to the longitudinal axis of the column in the direction of the bottom end of the column. The column is suitable for absorption and dewatering plants which are installed on floating platforms and ships. A liquid stream leading away from the column wall is avoided even in the event of an inclined position of the column. The formation of “dry” packing zones is thereby prevented.

The present invention relates to a column for bringing two fluids into contact, e.g. a gas with a liquid or two liquids of different density.

The crude gas produced in the extraction of natural gas frequently comprises a considerable fraction of acid gases such as, e.g., CO₂, H₂S, SO₂, CS₂, HCN, COS, NO_{N}, disulfides or mercaptans as impurities. The removal of acid gases is of particular importance for various reasons. Carbon dioxide, for example, must be removed from natural gas since a high concentration of CO₂ reduces the calorific value of the gas. In addition, CO₂ in combination with moisture which is frequently entrained in the fluid streams can lead to corrosion on pipes and fittings. The H₂S fraction of the crude gas is a problem especially for reasons of safety: H₂S is a high toxic respiratory poison for humans, animals and plants.

For removing acid gases, use is frequently made of scrubbing with aqueous solutions of organic bases, e.g. alkanolamines. In this process, the fluid and the absorption medium are conducted in opposite directions to one another in an absorption column. On dissolution of acid gases, ionic products form from the base and the acid gas components. The absorption medium can be regenerated by expansion to a lower pressure or by stripping, wherein the acid gases are liberated again and/or stripped off by means of steam. After the regeneration process, the absorption medium can be reused.

In the case of relatively small natural gas fields situated in the sea, erecting a pipeline to a gas scrubbing plant situated on the mainland is generally not economic. In order to be able to use these relatively small fields efficiently also, plants or plant components such as, for example, absorption plants and dewatering plants, come into consideration which are installed on floating platforms and ships anchored at the respective gas well and are operated during the production time of the well (what are termed FPSO plants; Floating Production, Storage and Offloading). Subsequently, the ships or platforms can be moved to other gas wells and used there.

Although these plants are anchored during their operation and so cannot carry out translatory movements, the rotary movements, in particular, of the ships or platforms lead to certain problems. Firstly, a greater or lesser lasting inclined position of the deck or the platform can occur. Secondly, movements of the ships or platforms such as, for example, heeling, pitching or yawing, lead to an unpredictably changing deviation from an exactly horizontal orientation of the deck or platform.

On account of the inclined position of the ship, gravity no longer acts in parallel to the axis of the absorption column but at an angle thereto. As a result, liquid is unevenly distributed over the column cross section. The direction of flow of the liquid flowing down in the column follows the effective direction of acceleration due to gravity. On the side facing away from the direction of slope, i.e. the elevated side of the column, the flow direction of the liquid receives a component pointing away from the column wall. There is the risk that parts of the packing run dry and thereby form zones without absorption. The efficiency of the absorption in such an inclined column is then given as a mixing parameter of zones having a high liquid loading (and good absorption) and zones having a low to absent liquid loading (and thereby poor to absent absorption).

In the case of floating plants which produce compressed liquid gas (floating LNG plants), this is, for example, of particular importance. Even relatively small bypass streams of the gas can make meeting strict LNG specifications (e.g. a maximum of 50 ppm CO₂) impossible. For a crude gas stream comprising 4% CO₂, for example the amount of CO₂ entrained by a small substream of 0.13% of the total gas stream which passes through the column without contact with the absorption liquid has the effect that a mean CO₂ specification of 50 ppm at the column outlet can no longer be met.

The object of the invention is to eliminate problems in the operation of absorption columns due to the inclined position of ships or floating platforms.

The object is achieved by a column for bringing two fluids into contact, which column possesses an essentially cylindrical shell which, between a top end and a bottom end of the column, surrounds an interior space in which axially spaced packings are arranged along a longitudinal axis extending from the top to the bottom end of the column, and in which the packings, at the periphery thereof, are bounded by side walls which are inclined to the longitudinal axis of the column in the direction of the bottom end of the column.

The invention in addition relates to a method of bringing two fluids into contact, which comprises introducing the lower density fluid in the region of the bottom end of the abovementioned column and introducing the higher density fluid in the region of the top end of the column and conducting it in countercurrent to the lower density fluid. In preferred embodiments, the lower density fluid is a gas and the higher density fluid is a liquid.

The inclination of the side walls preferably corresponds to the maximum expected heeling (inclined position) of the ships or platforms. In this manner it is possible to avoid a liquid stream leading away from the column wall being able to occur at a position on the periphery. This prevents the formation of “dry” and therefore absorption-free packing zones which permit unwanted gas-bypass streams.

The side walls are generally inclined at an angle of 0.25 to 5.0°, preferably 0.5 to 2°, to the longitudinal axis of the column.

A “cylindrical shell” is taken to mean not only bodies having a circular base, but also, e.g., those of an elliptical or polygonal base. However, bodies having a circular base are preferred.

The “packings” are column internals which act to intensify the mass transfer and/or heat exchange between the fluids. They increase the surface area or interfacial area between the fluids available for exchange processes. The packings to be used according to the invention are generally selected from packed beds and structured packings. The column generally comprises 1 to 5, preferably 1, 2 or 3, individual packings which are axially spaced from one another along the longitudinal axis of the column.

Suitable packings are known to those skilled in the art. They can have any desired shape such as ring-shaped, saddle-shaped, corrugated and the like, and can possess, e.g., outward-pointing projections and/or passage channels. The packings comprise, e.g., carbon steel, stainless steel, titanium or plastic. Those which have proven useful are, e.g., Raschig rings and/or Pall rings.

Structured packings are known per se to those skilled in the art and are described, e.g., in Chem. -Ing. Tech. 58 (1986) No. 1, pp. 19-31 and in the Technischen Rundschau Sulzer 2/1979, p. 49 et seq from Gebrüder Sulzer Aktiengesellschaft in CH-Winterthur. Those which have proven useful are, e.g., those marketed under the name Mellapak® (Sulzer), Flexipak® (Koch-Glitsch) or Rhombopak® (Montz).

Generally, the packings are held by holding appliances which are provided in the interior of the column, spaced axially from one another. Preferably, the holding appliances are holding plates. These are provided with suitable throughways for the ascending or descending fluid. Packed beds can be applied directly to such a holding plate.

Between the packings, generally suitable liquid distributors are provided. The liquid distributors collect the fluid flowing off from a packing situated thereabove and distribute it uniformly over the cross section of the packing lying below. Preferably, use is made of distributors which operate by the damming principle. The fluid runs with an elevated static inlet pressure via narrow orifices on the underside of the distributor appliance. Since, in the operating state, the damming height is generally significantly greater than the maximum height difference owing to the inclined position of the column, deviations from the horizontal orientation of the distributor device do not have such a great effect as in distributor systems which operate by the overflow principle. Suitable distributors are described, e.g., in EP 1386649 A1 or U.S. Pat. No. 6,294,053, or are commercially available.

The inclined side walls which border the packings at their periphery can be formed, e.g., from conically tapering metal sheets which are firmly attached, e.g. welded, to the column.

With respect to a simple implementation of the invention and for simplifying adaptations, however, it is preferred that the inclined side walls are formed by ring-shaped inserts having conical inner surfaces which are held by the holding appliances, e.g., support plates. The ring-shaped inserts can be inserted into existing columns and/or be detachably attached to the column. The ring-shaped inserts can, for example, be placed directly onto the support plates of a column.

Preferably, the outer surfaces of the ring-shaped inserts are adapted to the shell of the column. That is to say the ring-shaped inserts fill up the cross section of the column and are sealed gas-tightly at their periphery against the column wall.

The ring-shaped inserts can be fabricated from solid material, e.g. from carbon steel, stainless steel or else from plastic: preferably, however, they are constructed as hollow bodies in the context of saving weight and material.

For implementation of the invention, abovedescribed ring-shaped inserts can be placed onto the support plates of a column. The inserts seal tightly to the column wall. Into the funnel-shaped hollow space formed by the conical inner surfaces of the ring-shaped inserts, then, the packings are charged or the packing elements are inserted.

The invention therefore also relates to a method of retrofitting a column for bringing two fluids into contact in order to make the column suitable, e.g. for use on a ship or a floating platform. In this case ring-shaped inserts having conical inner surfaces are introduced into the column which possesses an essentially cylindrical shell, which shell, between a top end and a bottom end of the column, surrounds an interior space in which holding appliances for holding packings, e.g. holding plates, are axially spaced apart along a longitudinal axis extending from the top to the bottom end of the column, in such a manner that the ring-shaped inserts are held by the holding appliances, and packings, e.g. packed beds or structured packings, are introduced into the spaces bounded by the inner surfaces of the ring-shaped inserts.

The invention also avoids, in the event of inclined positions, zones in the columns in which only a restricted mass transfer or no mass transfer proceeds, such as, e.g. in dry zones. In a preferred embodiment, a column structure according to the invention is obtained by introducing conical ring-shaped inserts into existing columns; the columns, as are also the cone pieces used, are expedient to produce. The cross-sectional reduction of the column caused by the cone shape relates in this case not to the overall height of the column, but in each case only to the height of an individual packing and is therefore in total less. A subsequent adjustment or correction of the wall inclination by inserting a cone of a different inclination is possible without having to rebuild the column itself. Therefore, the invention may be implemented flexibly and inexpensively.

In a preferred embodiment of the method according to the invention, the lower density fluid is a hydrocarbon comprising acid gas, preferably a gaseous hydrocarbon comprising acid gas, and the higher density fluid is an acid gas absorption medium. The acid gas is selected, e.g., from CO₂, H₂S, SO₂, CS₂, HCN, COS, NOₓ, disulfides, mercaptans or mixtures of two or more thereof. Generally, the acid gas comprises at least CO₂ and/or H₂S.

The acid gas absorption medium is preferably an aqueous solution of at least one amine and/or of an amino acid metal salt. Such acid gas absorption media are familiar to those skilled in the art and are described in numerous patent publications.

The aqueous solution comprises, e.g. 2 to 6 kmol/m³, in particular 3.5 to 5 kmol/m³, amine and/or amino acid metal salt.

The amine is selected, e.g., from monoethanolamine (MEA), diethanolamine (DEA), methyldiethanolamine (MDEA), diisopropanolamine (DIPOA), dimethylaminopropanol (DMAP), methylaminodiisopropanol and mixtures thereof.

Preferred absorption media comprise an activator in the form of a primary or secondary amine. Preferred activators are saturated, 5- to 7-membered heterocyclic compounds having at least one NH group and if appropriate a further heteroatom in the ring selected from an oxygen atom and a nitrogen atom. Suitable activators are, e.g., piperazine, 2-aminobutanol, aminoethoxyethanol and methylaminopropylamine.

Preferred absorption media comprise at least one tertiary alkanolamine having 4 to 12 carbon atoms. Particularly preferred absorption media comprise at least one tertiary alkanolamine and an activator defined hereinbefore.

Suitable amino acid metal salts are alkali metal or alkaline earth metal salts of N-mono-C₁-C₄-alkyl-α-aminocarboxylic acids and N,N-di-C₁-C₄-alkyl-α-aminocarboxylic acids. Particular preference is given to the potassium salt of dimethylglycine or N-methylalanine.

The acid gas absorption medium can also comprise at least one physical acid gas solvent. The physical acid gas solvent is selected from, e.g., sulfolane and N-methyl-2-pyrrolidone (NMP).

In another preferred embodiment of the method according to the invention, the lower density fluid is a moisture-retaining hydrocarbon, preferably a gaseous hydrocarbon, and the higher density fluid is a moisture absorption medium.

The moisture absorption medium is selected, e.g., from monoethylene glycol (MEG), diethylene glycol (DEG) and triethylene glycol (TEG).

The hydrocarbon is preferably natural gas from reservoirs below the sea bed which is transported by means of off-shore wells. The natural gas which has been deacidified and/or dehumidified by the method according to the invention can then be transported by ship as compressed liquefied natural gas (LNG).

The invention will be illustrated in more detail by the accompanying drawings.

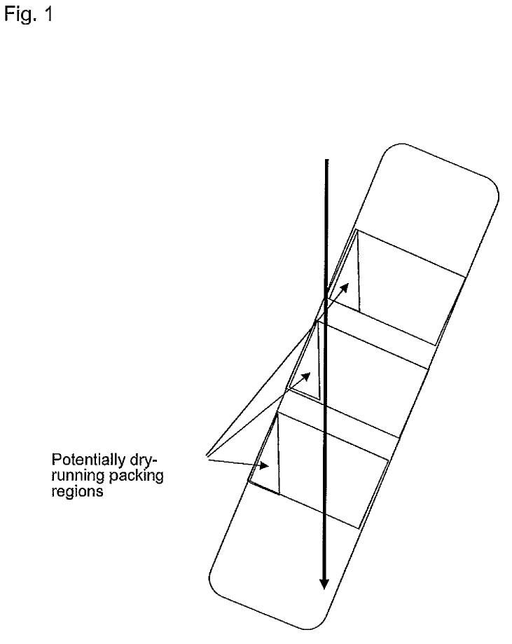

FIG. 1 shows the effective direction of gravity in an inclined column.

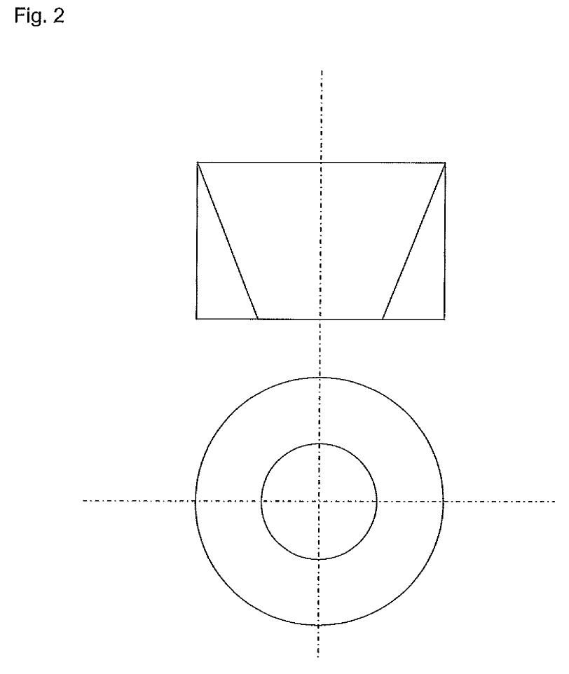

FIG. 2 shows a section and a plan view of ring-shaped column inserts having conical inner surfaces which are provided according to the invention.

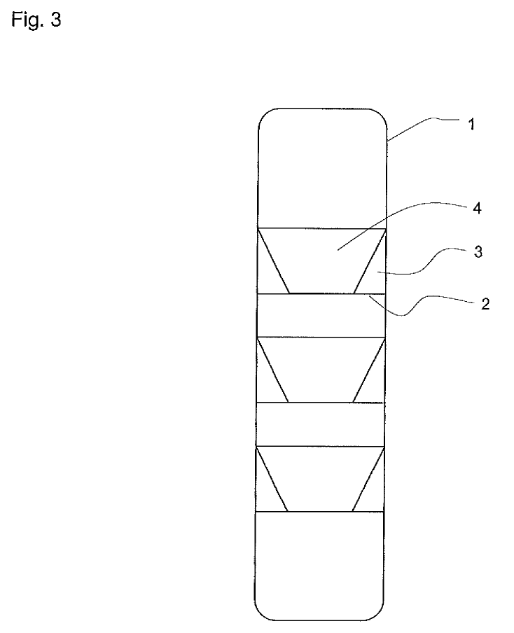

FIG. 3 shows a longitudinal section through a column according to the invention.

The effective direction of gravity is illustrated in FIG. 1 by the large arrow. In the event of an inclined position of a column such as, e.g., of an absorption column operated on a ship or on a floating platform, gravity no longer acts in the direction of the longitudinal axis of the column, as shown in FIG. 1. On the side facing away from the direction of inclination, parts of the packing can run dry and thereby form zones without absorption.

As shown in FIG. 3, a column according to the invention possesses an essentially cylindrical shell (1) and axially spaced packings (4) in the interior of the column. The packings are bounded at their periphery by side walls which are inclined downwards to the longitudinal axis of the column. The inclined side walls are formed by ring-shaped inserts (3) having conical inner surfaces. The inserts rest on support plates (2). In the funnel-shaped hollow space formed by the conical inner surfaces of the ring-shaped inserts, packings are charged, or packing elements are inserted. Between the packings, suitable liquid distributors are generally provided (not shown).

The ring-shaped inserts having conical inner surfaces are shown in FIG. 2 in section and plan view. The outer surfaces of the ring-shaped inserts are adapted to the shell of the column.

1.-18. (canceled)

19. A column for bringing two fluids into contact, comprising an essentially cylindrical shell which, between a top end and a bottom end of the column, the shell surrounds an interior space in which axially spaced packings are arranged along a longitudinal axis extending from the top to the bottom end, wherein a periphery of the packings are bounded by side walls which are inclined toward the longitudinal axis in the direction of the bottom end.

20. The column according to claim 19, wherein the packings are selected from packed beds and structured packings.

21. The column according to claim 19, wherein the packings are held by holding appliances which are provided in the interior of the column, spaced axially from one another.

22. The column according to claim 21, wherein the inclined side walls are formed by ring-shaped inserts having conical inner surfaces which are held by the holding appliances.

23. The column according to claim 22, wherein the outer surfaces of the ring-shaped inserts are matched to the shell of the column.

24. The column according to claim 19, wherein liquid distributors are provided between the packings.

25. The column according to claim 19, wherein the side walls are inclined at an angle of 0.5 to 2.0° to the longitudinal axis of the column.

26. A method of bringing a lower density fluid into contact with a higher density fluid, the method comprising:
introducing the lower density fluid into a region at a bottom end of a column, the column having an essentially cylindrical shell which, between a top end and a bottom end of the column, surrounds an interior space in which axially spaced packings are arranged along a longitudinal axis extending from the top to the bottom end, wherein a periphery of the packings are bounded by side walls which are inclined toward the longitudinal axis in the direction of the bottom end;
introducing the higher density fluid into a region of the top end of the column; and
conducting the higher density fluid in countercurrent to the lower density fluid.

27. The method according to claim 26, wherein the lower density fluid is a hydrocarbon comprising acid gas and the higher density fluid is an acid gas absorption medium.

28. The method according to claim 27, wherein the acid gas absorption medium is an aqueous solution of at least one amine and/or one amino acid metal salt.

29. The method according to claim 28, wherein the amine is selected from monoethanolamine (MEA), diethanolamine (DEA), methyldiethanolamine (MDEA), diisopropanolamine (DIPOA), dimethylaminopropanol (DMAP), methylaminodiisopropanol and mixtures thereof.

30. The method according to claim 29, wherein the acid gas absorption medium in addition comprises at least one activator selected from piperazine, 2-aminobutanol, aminoethoxyethanol and methylaminopropylamine.

31. The method according to claim 27, wherein the acid gas absorption medium comprises at least one physical acid gas solvent.

32. The method according to claim 31, wherein the physical acid gas solvent is selected from sulfolane and N-methyl-2-pyrrolidone (NMP).

33. The method according to claim 26, wherein the lower density fluid is a moisture-retaining hydrocarbon, and the higher density fluid is a moisture absorption medium.

34. The method according to claim 33, wherein the moisture absorption medium is selected from monoethylene glycol (MEG), diethylene glycol (DEG) and triethylene glycol (TEG).

35. The method according to claim 26, wherein the column is arranged on a ship or on a floating platform.

36. A method of retrofitting a column for bringing two fluids into contact, the column comprising an essentially cylindrical shell which, between a top end and a bottom end of the column, surrounds an interior space in which holding appliances for holding packings are axially spaced apart along a longitudinal axis extending from the top to the bottom end, the method comprising:
introducing ring-shaped inserts having conical inner surfaces into the column such that the ring-shaped inserts are held by the holding appliances; and
introducing packings into the spaces bounded by the inner surfaces of the ring-shaped inserts.
